(19) United States
(12) Patent Application Publication
(10) Pub. No.: US 2015/0093619 A1
(43) Pub. Date: Apr. 2, 2015

(54) BATTERY AND METHOD FOR MANUFACTURING BATTERY

(71) Applicant: GS Yuasa International Ltd., Kyoto-shi (JP)

(72) Inventors: Mitsuhiro KODAMA, Kyoto (JP); Manabu KANEMOTO, Kyoto (JP)

(21) Appl. No.: 14/496,733

(22) Filed: Sep. 25, 2014

(30) Foreign Application Priority Data
Sep. 30, 2013 (JP) 2013-204838

(51) Int. Cl. H01M 10/04; H01M 4/38; H01M 2/02; H01M 4/52

(52) U.S. Cl. CPC H01M 10/0431; H01M 4/52; H01M 4/383; H01M 2/02
USPC 429/94; 29/623.2

(57) ABSTRACT

A battery includes a case and an electrode group disposed in the case and formed by winding electrodes. Lengths of the electrodes in a direction of a winding axis of the electrode group are smaller than a length of a housing space in the case in the direction of the winding axis of the electrode group. The electrode group is formed by helically winding the electrodes.

### CROSS-REFERENCE TO RELATED APPLICATIONS

This application is based on Japanese Patent Application No. 2013-204838 filed on Sep. 30, 2013, the entire contents of which is hereby incorporated by reference.

### FIELD

The present invention relates to a technique of an inner structure of a battery.

### BACKGROUND

In recent years, needs for inexpensive batteries are growing. Therefore, there has been developed a battery, for example, including, in a battery case, an electrode group formed by a positive electrode plate, a negative electrode plate, and separators impregnated with electrolyte solution, in which the electrode group is short in an axial direction of the battery case and a spacer is disposed in a remaining space in the battery case. In this way, smaller amounts of electrodes are used than in a case where an electrode group is formed throughout an axial length of the battery, which reduces cost of the battery. Moreover, the spacer suppresses rattling of the electrode group in the battery case (DE 200 16 231 U1).

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In the above-described prior art, the electrode group is short in the axial direction of the battery case and the spacer is disposed in the remaining space in the battery case, which increases the number of parts of the battery and also increases the number of steps of production. Therefore, reduction of the amounts of electrodes to be used without using the member such as the spacer is required.

The present specification discloses a technique capable of reducing amounts of electrodes to be used while suppressing rattling of an electrode group in a case such as a battery case without use of a member such as a spacer or with minimal use of it.

A battery according to an aspect of the present invention includes a case and an electrode group disposed in the case and formed by winding electrodes. Lengths of the electrodes in a direction of a winding axis of the electrode group are smaller than a length of a housing space in the case in the direction of the winding axis of the electrode group and the electrode group is formed by helically winding the electrodes.

### BRIEF DESCRIPTION OF THE DRAWINGS

The foregoing and other features of the present invention will become apparent from the following description and drawings of an illustrative embodiment of the invention in which:

FIG. 1 shows a perspective view showing a vertical section of a battery of an embodiment;

FIG. 2 shows a vertical sectional view of the battery of the embodiment;

FIG. 3 shows an exploded perspective view of the battery of the embodiment; and

FIG. 4 shows a perspective view of a metal plate of the embodiment on which active material is loaded or applied.

### DESCRIPTION OF EMBODIMENT

A battery according to an aspect of the present invention includes a case and an electrode group disposed in the case and formed by winding electrodes. Lengths of electrodes in a direction of a winding axis of the electrode group are smaller than a length of a housing space in the case in the direction of the winding axis of the electrode group. The electrode group is formed by helically winding the electrodes.

According to the aspect of the present invention, as compared with an ordinary structure in which electrodes are not helically wound, it is possible to reduce amounts of electrodes to be used while suppressing rattling of the electrode group in the case without use of a member such as a spacer or with minimal use of it.

The electrode group in the battery may be formed by a positive electrode plate and a negative electrode plate and the positive electrode plate and the negative electrode plate are wound into a stepped shape.

Accordingly, as compared with the ordinary structure in which the electrodes are not helically wound, it is possible to reduce the amounts of electrodes to be used while suppressing rattling of the electrode group in the case without use of the member such as the spacer or with minimal use of it.

In the electrode group of the battery, the paired positive electrode plate and the negative electrode plate facing each other may be wound into a stepped shape.

Accordingly, as compared with a structure in which parts of wound positive electrode plate and negative electrode plate are facing each other, it is possible to further suppress generation of areas which are not used as electrodes.

In the aspect of the present invention, outermost end edges of the electrodes of the electrode group may be inclined with respect to the direction along the winding axis of the electrode group.

Accordingly, as compared with a structure in which an electrode group is accidentally unwound into a helical shape, it is possible to suppress the amounts of electrodes to be used while maintaining uniform battery performance.

In the aspect of the present invention, outermost end edges of the electrodes of the electrode group may be parallel to the direction along the winding axis of the electrode group.

Accordingly, as compared with a structure in which outermost end edges of electrodes are inclined with respect to a direction along a winding axis of an electrode group, it is possible to further suppress the amount of electrode group to be used.

In the aspect of the present invention, the case may include a lid body, a central portion of the electrode group, which is close to the winding axis may be formed by the positive electrode plate, a peripheral portion of the electrode group, which is wound around the central portion may be formed by the negative electrode plate, the central portion may be closer to the lid body than the peripheral portion, the central portion and the lid body may be connected, and the peripheral portion and the case may be connected.

Accordingly, as compared with a structure in which a central portion is farther from a lid body than a peripheral portion, a distance for connecting the lid body and the central portion is shorter and therefore it is possible to suppress increase in internal resistance of the battery.

In the battery one of the electrodes may include nickel hydroxide and the other of the electrodes may include hydrogen storage alloy.

A method for manufacturing a battery according to another aspect of the present invention includes: opposing a band-shaped positive electrode plate and a band-shaped negative electrode plate to each other to obtain a band-shaped electrode group, winding the band-shaped electrode group at an angle with respect to a short-side direction of the band-shaped electrode group to obtain the helically wound electrode group, and housing the wound electrode group into a case.

According to another aspect of the present invention, the helically wound electrode group can be easily formed and it is possible to reduce amounts of electrodes to be used while suppressing rattling of the electrode group in the case without use of a member such as a spacer or with minimal use of it.

In the method of manufacturing the battery according to another aspect of the present invention, lengths of the band-shaped positive electrode plate and the band-shaped negative electrode plate in a direction of a winding axis of the electrode group are smaller than a length of a housing space in the case in the direction of the winding axis of the electrode group.

### First Embodiment

### Structure of Battery

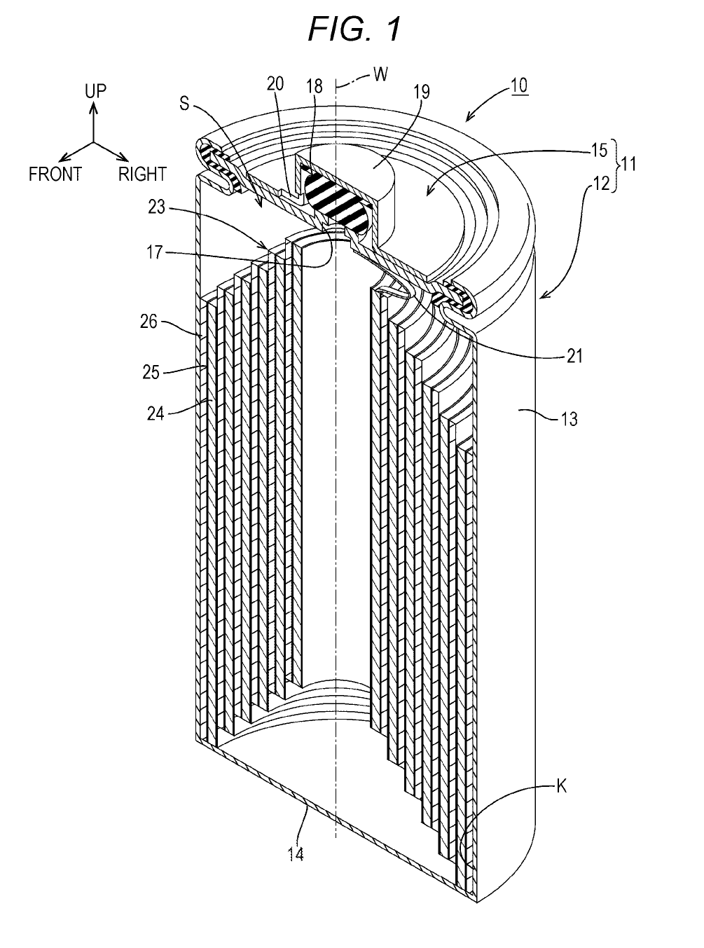

The battery 10 of a first embodiment will be described with reference to FIGS. 1 to 4. The battery 10 is an alkaline storage battery such as a nickel-metal hydride rechargeable battery. The battery 10 is an HR6 (according to IEC (International Electrotechnical Commission) or AA (in the United States) battery with a capacity of 2300 mAh or lower or an HR03 (according to IEC) or AAA (in the United States) with a capacity of 800 mAh or lower. In the following description, a front side of a paper surface of FIG. 1 will be referred to as a front side (front) of the battery 10, a right side of the paper surface will be referred to as a right side (right) of the battery 10, and an upper side of the paper surface will be referred to as an upper side (up) of the battery 10.

As shown in FIG. 1, the battery 10 is formed by the battery case 11 and the electrode group 23. The battery case 11 is made of metal and has a shape which is long in one direction. The battery case 11 is an example of the case and formed by a battery case main body 12 and the lid portion 15 and has the housing space S inside itself. The one direction may be referred to as the longitudinal direction of the battery case 11 in some cases and is a vertical direction in FIG. 1 and a direction facing the lid portion 15 and a closed portion 14 (described later).

The battery case main body 12 has a nickel-plated surface and serves as a negative electrode terminal of the battery 10 when a negative electrode plate 26 (described later) is electrically connected to the battery case main body 12. The battery case main body 12 has a cylindrical shape with a bottom which is open at one end in the longitudinal direction and closed at the other end. To put it concretely, the battery case main body 12 has a cylindrical portion 13 and the closed portion 14.

The cylindrical portion 13 has a cylindrical shape which is long in the longitudinal direction. A shape of an inner peripheral face seen from the longitudinal direction is a perfect circle having a constant inner diameter R a center of which is a central axis W along the longitudinal direction. An inside of the cylindrical portion 13 is the housing space S which can house the electrode group 23 (described later).

At one end in one direction of the cylindrical portion 13, i.e., an upper end in FIG. 1, an opening portion 12A communicating with an inside of the cylindrical portion 13 is formed. At the other end in one direction of the cylindrical portion 13, i.e., a lower end in FIG. 1 is closed with the closed portion 14. The closed portion 14 has a circular flat plate shape and is formed integrally with the cylindrical portion 13.

The lid portion 15 (an example of the lid body) is electrically connected to the positive electrode plate 24 (described later) with a connecting terminal 21 having elasticity interposed therebetween and serves as a positive electrode terminal of the battery 10. The lid portion 15 includes a lid main body 16, an elastic body 18, and a terminal plate 19. The lid main body 16 is a circular flat plate, made of substance such as nickel-plated iron material having electric conductivity, and electrically connected to the positive electrode plate 24 with the connecting terminal 21 interposed therebetween. A through hole 17 is formed at a central portion of the lid main body 16.

The elastic body 18 is disposed on an upper face of the lid main body 16, i.e., a face opposite from a face facing the closed portion 14 so as to close the through hole 17. The elastic body 18 is made of material such as rubber and is elastically deformed in response to an external force. The terminal plate 19 is an electrically conductive plate covering the elastic body 18.

To put it concretely, the terminal plate 19 is electrically connected to the lid main body 16 while pressing the elastic body 18 downward, i.e., against the lid main body 16. A release hole 20 for releasing gas in the battery case 11 is formed in the terminal plate 19. For example, if internal pressure of the battery case 11 increases and the elastic body 18 receives pressure of a predetermined or higher value from the through hole 17, the elastic body 18 is elastically deformed to connect an inside of the battery case 11 and the release hole 20 and the gas in the battery case 11 is released outside the battery 10 from the release hole 20.

An elastically deformable insulating body 22 is sandwiched between an opening portion 12A of the battery case main body 12 and the lid portion 15 to seal the opening portion 12A. The insulating body 22 insulates the battery case main body 12 and the lid portion 15 from each other.

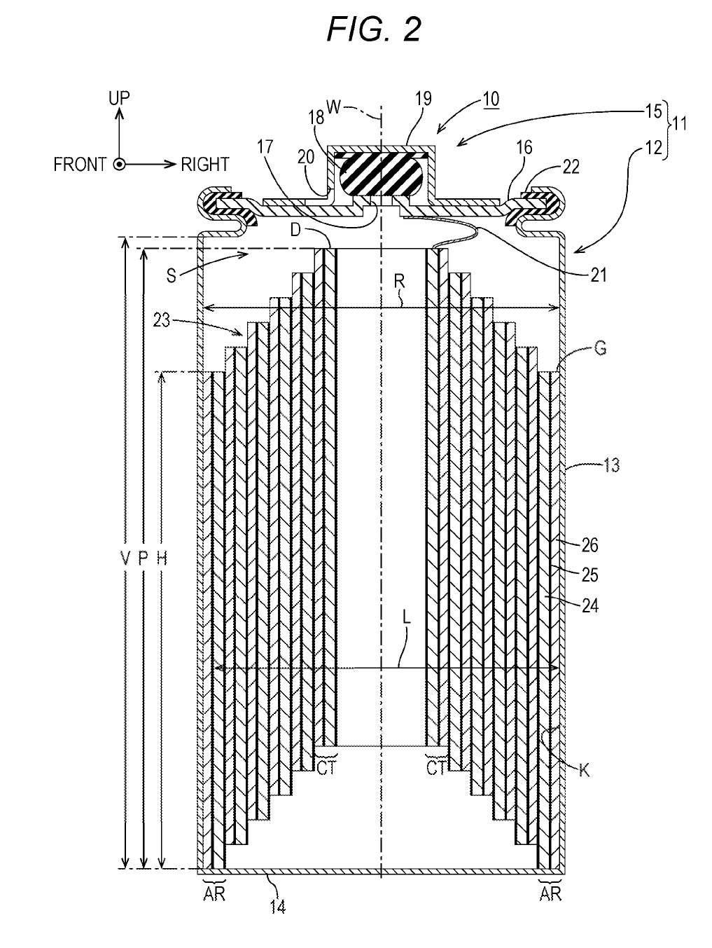

The electrode group 23 is housed in the housing space S in the battery case 11. In at least one of housing spaces above and below the electrode group, a member other than the electrode group, e.g., an insulating member formed by an insulating body may be disposed. The electrode group 23 is formed by helically winding the positive electrode plate 24, the negative electrode plate 26, and separators 25 disposed between the positive electrode plate 24 and the negative electrode plate 26 and including electrolyte solution about a winding axis along the longitudinal direction. More specifically, the positive electrode plate 24 and the negative electrode plate 26 are helically wound about the winding axis while facing each other with the separators 25 interposed therebetween. Therefore, as shown in FIGS. 1 and 2, in a vertical section of the battery 10, the positive electrode plate 24 and the negative electrode plate 26 are wound into a stepped shape about the winding axis while facing each other with the separators 25 interposed therebetween. The winding axis may or may not be aligned with the above-mentioned central axis W. However, in the following description, for convenience of description, the winding axis is aligned with the central axis W.

The positive electrode plate 24 is formed by loading positive active material 24B to a positive electrode metal plate 24A. The positive electrode metal plate 24A is made of foamed nickel, for example. The positive active material 24B is a mixture of positive nickel hydroxide active material and a cobalt compound as conductive material. The positive electrode plate 24 is an electrode formed by loading the positive active material 24B into hollows in the positive electrode metal plate 24A.

If the battery 10 is a nickel-cadmium rechargeable battery, the positive active material 24B is nickel hydroxide, for example. If the battery 10 is the nickel-metal hydride rechargeable battery, the nickel hydroxide active material is nickel hydroxide to which calcium hydroxide is added, for example.

The negative electrode plate 26 is formed by applying negative active material 26B to a negative electrode metal plate 26A. The negative electrode metal plate 26A is a nickel-plated perforated steel plate, for example. The negative active material 26B is cadmium powder or hydrogen storage alloy powder, for example. The negative electrode plate 26 is an electrode formed by applying the negative active material 26B onto the negative electrode metal plate 26A.

If the battery 10 is the nickel-cadmium rechargeable battery, the negative active material 26B is a mixture of cadmium oxide powder and metallic cadmium powder, for example. If the battery 10 is the nickel-metal hydride rechargeable battery, the negative active material is mainly AB5-type (rare earth, Ni), AB3.0-3.8 type (rare earth, Mg—Ni) or AB2-type (Laves phase) hydrogen storage alloy powder, for example.

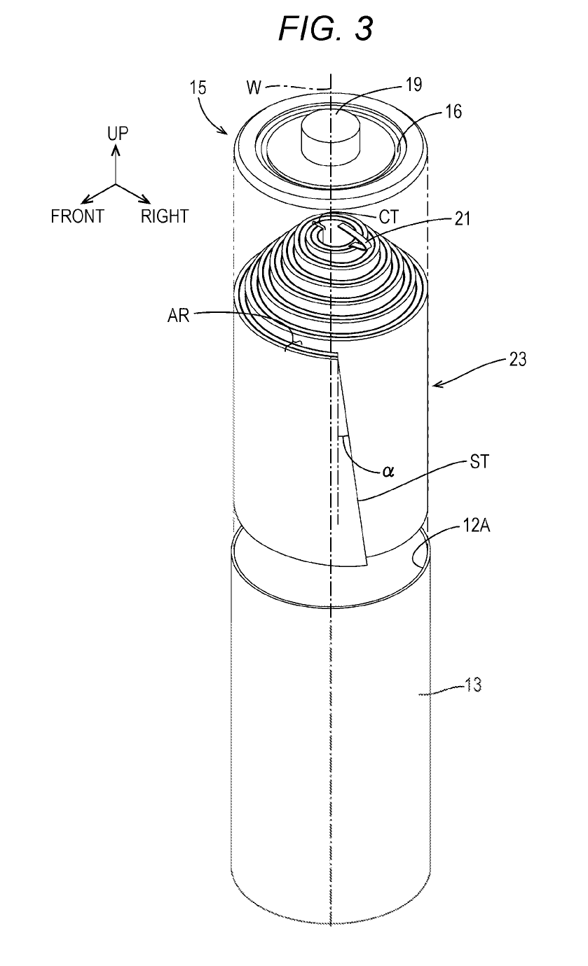

As shown in FIG. 3, in the electrode group 23, the positive electrode plate 24 and the negative electrode plate 26 are helically wound about the central axis W while facing each other with the separators 25 interposed therebetween. Therefore, the central portion CT of the electrode group 23 wound at a position close to the central axis W and the peripheral portion AR wound around the central portion CT are different in a position of one end in the longitudinal direction, i.e., a direction along the central axis W. To put it concretely, in the electrode group 23, one end D in the longitudinal direction of the central portion CT is positioned above one end G in the longitudinal direction of the peripheral portion AR.

More specifically, the position of the one end in the longitudinal direction of the electrode group 23 descends step by step downward from the one end D in the longitudinal direction of the central portion CT toward the one end G in the longitudinal direction of the peripheral portion AR. In other words, the one end in the longitudinal direction of the electrode group 23 is the closest to the lid portion 15 at the one end D in the longitudinal direction of the central portion CT. The positive electrode plate 24 of the central portion CT and the lid portion 15 are connected by a lead wire 21. An outer diameter of the peripheral portion AR, a center of which is the central axis W along the longitudinal direction, is a maximum outer diameter L of the electrode group 23.

An inner diameter R of the cylindrical portion 13 described above is substantially equal to the outer diameter L of the electrode group 23. In this way, the electrode group 23 is in contact with an inner side face K of the cylindrical portion 13 at the peripheral portion AR. More specifically, the negative electrode plate 26 of the electrode group 23 is in contact with the inner side face K of the cylindrical portion 13. The inner side face K of the cylindrical portion 13 is a face along the longitudinal direction among an inner face of the battery case 11.

The electrode group 23 is preferably press-fitted into the housing space S. If the electrode group 23 is press-fitted into the housing space S, a force perpendicular to the longitudinal direction, i.e., a force from front, back, left, and right sides toward the central portion CT acts on the peripheral portion AR in contact with the inner side face K of the cylindrical portion 13. This maintains the structure in which the one end D in the longitudinal direction of the central portion CT of the electrode group 23 is positioned above the one end G in the longitudinal direction of the peripheral portion AR.

In order to maintain the structure in which the one end D in the longitudinal direction of the central portion CT of the electrode group 23 is positioned above the one end G in the longitudinal direction of the peripheral portion AR, a retaining body conforming to a wound shape of the electrode group 23 may be provided above or below the electrode group 23.

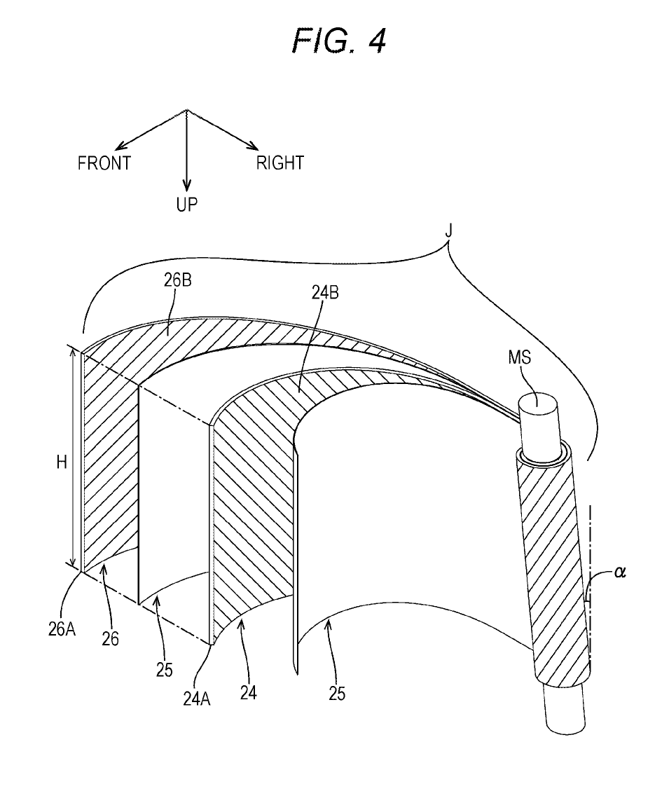

An outermost end edge ST of the electrode group 23 positioned on an outer side of the electrode group 23 is formed in a direction different from the longitudinal direction, i.e., the direction along the central axis W. This will be described below in detail with reference to FIG. 4.

### (Manufacture of Electrode Plates)

As shown in FIG. 4, the electrode group 23 is formed by disposing and winding the positive electrode plate 24 and the negative electrode plate 26 with the separators 25 interposed therebetween. The positive electrode plate 24, the negative electrode plate 26, and the separators 25 are in shapes of band-shaped rectangles which are long in one direction. The positive electrode plate 24, the negative electrode plate 26, and the separators 25 have substantially equal widths H in the longitudinal direction, i.e., a short-side direction and substantially equal lengths J in a left-right direction, i.e., a long-side direction.

The positive electrode plate 24 and the negative electrode plate 26 are wound about a winding core MS which serves as the winding axis while facing the separators 25. At this time, the winding core MS is at a certain angle α with respect to the short-side direction of the positive electrode plate 24 and the like. The positive electrode plate 24, the negative electrode plate 26, and the separators 25 are wound around the winding core MS and therefore are helically wound.

The winding core MS is at the certain angle α with respect to the short-side direction of the positive electrode plate 24 and the like. Therefore, the outermost end edge ST of the electrode group 23 after the winding is formed in a direction different from the direction along the central axis W. To put it concretely, the outermost end edge ST is formed at the angle α with respect to the direction along the central axis W.

As shown in FIG. 2, in the longitudinal direction of the electrode group 23, a length P of the electrode group 23 after winding of the positive electrode plate 24, the negative electrode plate 26, and the separators 25 is greater than the widths H of the positive electrode plate 24, the negative electrode plate 26, and the separators 25 before the winding. The widths H are smaller than a longitudinal length V of the housing space S. The longitudinal length V of the housing space S corresponds to a length of the housing space S in the direction of the central axis W. The length P is equal to or smaller than the length V. Here, if the member other than the electrode group, e.g., the insulating member formed by the insulating body or the like is disposed in at least one of the housing spaces above and below the electrode group, a difference obtained by subtracting a height of the member from the longitudinal length of the housing space S is regarded as a longitudinal length V of the housing space S.

On the other hand, if a winding core MS is not at the certain angle α with respect to a short-side direction of a positive electrode plate 24 and the like, i.e., if α=0°, the following electrode group 23 is obtained. In other words, if the positive electrode plate 24 and a negative electrode plate 26 are wound about the winding core MS while facing separators 25, they are wound into a circular columnar shape having a length H in a winding axis direction. In this case, the electrode group 23 formed by winding has a longitudinal length H both at a central portion CT and a peripheral portion AR. Because the length H is smaller than a length V, the electrode group 23 rattles in a housing space S as compare with the case in which the electrode group 23 is formed into the helical shape.

Therefore, it is possible to suppress amounts of electrodes to be used while suppressing rattling of the electrode group 23 as compared with the structure in which the positive electrode plate 24 and the negative electrode plate 26 are not helically wound while facing each other with the separators 25 interposed therebetween.

The separators 25 are made of polyolefin nonwoven fabric. The separators 25 are impregnated with electrolyte solution mainly including potassium hydroxide or sodium hydroxide. The separators 25 are not disposed on a face of the electrode group 23 facing the inner side face K of the cylindrical portion 13. On the face facing the inner side face K of the cylindrical portion 13, the negative electrode plate 26 is disposed.

### Effects of the Embodiment

According to a first aspect of the invention, in the electrode group 23, the positive electrode plate 24 and the negative electrode plate 26 are helically wound about the central axis W while facing each other with the separators 25 interposed therebetween. The electrode group 23 is housed in the housing space S in the battery case 11. Because the electrode group 23 is helically wound, in the longitudinal direction of the electrode group 23, the length P of the electrode group 23 after winding of the positive electrode plate 24, the negative electrode plate 26, and the separators 25 is greater than the widths H of the positive electrode plate 24, the negative electrode plate 26, and the separators 25 before the winding. The widths H and the length P are smaller than the longitudinal length V of the housing space S.

Therefore, it is possible to suppress rattling of the electrode group 23 in the battery case 11 while suppressing amounts of electrodes to be used as compared with the structure in which the electrode group 23 is not helically wound.

As described above, there are standards for the battery 10 and there are also standards for the longitudinal length of the battery case 11 (the longitudinal length V of the housing space S). In the embodiment, by making the longitudinal length of the electrode group 23 smaller than the entire length of the housing space S while maintaining the longitudinal length V of the housing space S which cannot be changed because of the standards, it is possible to reduce the amounts of electrodes to be used while maintaining standards for watt-hour.

When the other electrode group which is not helically wound is housed into the housing space S, the electrode group may be accidentally unwound into a helical shape, for example. In this case, areas where the positive electrode plate and the negative electrode plate are not facing each other may be formed on the other electrode group. The areas where the positive electrode plate and the negative electrode plate are not facing each other do not function as electrodes.

On the other hand, in the electrode group 23, the positive electrode plate 24 and the negative electrode plate 26 are helically wound about the central axis W while facing each other with the separators 25 interposed therebetween. Therefore, it is possible to suppress the amounts of electrodes to be used while maintaining uniform battery performance as compared with the structure in which the other electrode group not helically wound is accidentally unwound into the helical shape.

Furthermore, the positive electrode plate 24, the negative electrode plate 26, and the separators 25 are wound about the winding core MS which is at the certain angle α with respect to the short side perpendicular to the winding direction of the electrode group 23. In other words, by changing a winding angle by the winding core MS, it is possible to use existing manufacturing equipment for the electrode group 23 as it is. Therefore, it is possible to suppress spending on equipment for manufacturing the electrode group 23.

### Other Embodiments

The technique disclosed in the present specification is not limited to the embodiment described by the above description and the drawings but includes the following various forms, for example.

In the example described in the above embodiment, the positive electrode plate 24, the negative electrode plate 26, and the separators 25 are helically wound upward in the longitudinal direction about the winding axis in the electrode group 23. However, the invention is not limited to it. An electrode group 23 may be helically wound downward in a longitudinal direction, for example.

In the example described in the above embodiment, the cylindrical portion 13 is in the cylindrical shape. However, the invention is not limited to it. A cylindrical portion 13 may be in a prismatic shape.

In the example described in the above embodiment, after the winding, the outermost end edge ST of the electrode group 23 is in the direction different from the direction along the central axis W, and more specifically, at the angle α with respect to the direction along the central axis W. However, the invention is not limited to it. An outermost end edge ST of an electrode group 23 after winding may be adjusted by cutting or the like so as to be in the same direction as a direction along a central axis W.

In the example described in the above embodiment, the positive electrode plate 24, the negative electrode plate 26, and the separators 25 have the equal the widths H in the longitudinal direction, i.e., the direction perpendicular to the winding direction of the electrode group 23 and the equal lengths J in the left-right direction, i.e., the winding direction of the electrode group 23. However, the invention is not limited to it. Separators 25 may have greater widths in a longitudinal direction than a positive electrode plate 24 and a negative electrode plate 26.

In the example described in the above embodiment, the one end D in the longitudinal direction of the central portion CT of the electrode group 23 is positioned above the one end G in the longitudinal direction of the peripheral portion AR. However, the invention is not limited to it. One end D in a longitudinal direction of a central portion CT of an electrode group 23 may be positioned below one end G in the longitudinal direction of a peripheral portion AR.

In the structure described in the above embodiment, the position of the one end in the longitudinal direction of the electrode group 23 descends step by step downward from the one end D in the longitudinal direction of the central portion CT toward the one end G in the longitudinal direction of the peripheral portion AR. However, the invention is not limited to it. A position of one end in a longitudinal direction of an electrode group 23 may not descend step by step downward but may finally descend downward while changing in the longitudinal direction. Alternatively, a position of one end in a longitudinal direction of an electrode group 23 may ascend step by step upward from one end D in the longitudinal direction of a central portion CT toward one end G in the longitudinal direction of a peripheral portion AR. In short, the positive electrode plate 24 and the negative electrode plate 26 forming the electrode group 23 may be wound into the stepped shape.

In the example described in the above embodiment, the paired positive electrode plate 24 and negative electrode plate 26 facing each other are wound into the stepped shape. However, the invention is not limited to it. A positive electrode plate 24 and a negative electrode plate 26 may be wound into a stepped shape. In other words, the positive electrode plate 24 and the negative electrode plate 26 may be helically wound while displaced little by little from each other in a direction of a winding axis. With this structure, it is possible to suppress amounts of electrodes to be used while suppressing rattling of an electrode group 23.

What is claimed is:

1. A battery comprising:
a case; and
an electrode group disposed in the case and formed by winding electrodes,
wherein lengths of the electrodes in a direction of a winding axis of the electrode group are smaller than a length of a housing space in the case in the direction of the winding axis of the electrode group, and
the electrode group is formed by helically winding the electrodes.

2. The battery according to claim 1, wherein the electrode group is formed by a positive electrode plate and a negative electrode plate and the positive electrode plate and the negative electrode plate are wound into a stepped shape.

3. The battery according to claim 1, wherein, in the electrode group, the paired positive electrode plate and negative electrode plate are wound into a stepped shape while facing each other.

4. The battery according to claim 1, wherein an outermost end edge of the electrode of the electrode group is inclined with respect to the direction along the winding axis of the electrode group.

5. The battery according to claim 1, wherein outermost end edge of the electrode of the electrode group is parallel to the direction along the winding axis of the electrode group.

6. The battery according to claim 1,
wherein the case includes a lid body,
a central portion of the electrode group, which is close to the winding axis, is formed by the positive electrode plate,
a peripheral portion of the electrode group, which is wound around the central portion, is formed by the negative electrode plate,
the central portion is closer to the lid body than the peripheral portion,
the central portion and the lid body are connected, and
the peripheral portion and the case are connected.

7. The battery according to claim 1,
wherein one of the electrodes includes nickel hydroxide, and
the other of the electrodes includes hydrogen storage alloy.

8. A method for manufacturing a battery, the method comprising:
opposing a band-shaped positive electrode plate and a band-shaped negative electrode plate to each other to obtain a band-shaped electrode group;
winding the band-shaped electrode group at an angle with respect to a short-side direction of the band-shaped electrode group to obtain the helically wound electrode group; and
housing the wound electrode group into a case.

9. The method of manufacturing the battery according to claim 8,
wherein lengths of the band-shaped positive electrode plate and the band-shaped negative electrode plate in a direction of a winding axis of the electrode group are smaller than a length of a housing space in the case in the direction of the winding axis of the electrode group.
